(19) United States
(12) Patent Application Publication
(10) Pub. No.: US 2018/0189848 A1
(43) Pub. Date: Jul. 5, 2018

(54) System and Method for Building a Network Platform of Knowledge Value-Realization

(71) Applicant: Lichen Sunfeng, Shenzhen (CN)

(72) Inventor: Lichen Sunfeng, Shenzhen (CN)

(21) Appl. No.: 15/657,205

(22) Filed: Jul. 24, 2017

(30) Foreign Application Priority Data
Dec. 14, 2016 (CN) 201611150250.9

(51) Int. Cl. G06Q 30/06; G06F 17/30; H04L 29/06

(52) U.S. Cl. CPC G06Q 30/0609; G06F 17/3089; G06F 17/30867; G06F 17/30554; H04L 63/08; G06F 17/3053

(57) ABSTRACT

The disclosure provides a system and method for building a network platform of knowledge value-realization, wherein the public recognition is obtained for the content rating based on the knowledge published by the user and the user rating is performed based on the user credit system on the website, to form a knowledge ranking list to fully display the user and its contribution to the knowledge content through the public rating; based on the public rating results on a user knowledge display module, the user can refer to and select forms of paying for Q & A such as reward question, invitation to answer and Q & A service to interact with other users, to achieve the market-oriented matchmaking trading and rapid realization of knowledge value.

### BACKGROUND OF THE DISCLOSURE

### 1. Field of the Invention

The disclosure relates to the field of network technology, and more particularly to a system and method for building a network platform of knowledge value-realization.

### 2. Description of the Related Art

The Q & A community and forum mainly based on the free charge and mutual assistance are widely used in the existing (knowledge Q & A) website; therefore, there is obviously no the realization of knowledge; there are some (knowledge-paid) websites with the user level system but without strict permission setting, or only the contents and quantity output by the user on these websites are counted but the quality is not controlled effectively, so that the “realization” efforts often are lack of convincing power and practical results. On the existing network platform, the “knowledge value-realization” fails to allow the user to identify and trust the value of knowledge (possessed and contributed by other users) and also fails to make the knowledge (possessed and contributed by the user) achieve its monetary value in a fair and effective manner in the form of paying for Q & A. Currently, the knowledge Q & A website lacks a strict and effective rating mechanism for the contents output by the user and lacks the rating and permission setting for the participant; meanwhile, during the knowledge value-realization in the form of paying for Q & A, often because the Q & A process is not clear, the questioner and the answerer have doubt about it (the questioner is worried that the answer quality is not high and the answerer is worried that the reasonable reward cannot be obtained); therefore, it is extremely limited for the realization of knowledge value of the user and the promotion of user activeness: there is lack of comprehensive level design of the user (and knowledge output by the user) and the investigation of the user (and knowledge output by the user) is naturally one-sided and inaccurate, so that the user (and content output by the user) often has a low credibility and the user's potential “aggressiveness” (activeness) cannot be motivated; the paid Q & A process lacks the strict rule design, so that the questioner is always worried that the answer quality is not high and the effective service cannot be obtained with the reward, or lacks the effective questioning judgment basis and “after-sales” evaluation mechanism; the answerer is often worried that the reasonable reward cannot be obtained timely after trying to answer the question. If the doubt of the questioner and the answerer cannot be eliminated through a clear process, the “rewarding good performance and punishing poor performance” has no effect on the user, resulting in the spread of poor content and the poor decline in the website interaction.

In conclusion, the existing Q & A website lacks a strict and effective rating mechanism for the contents output by the user and is extremely limited for the realization of knowledge value of the user and the promotion of user activeness: the user has a low credibility; the paid Q & A process lacks the strict rule design, so that the questioner is always worried that the answer quality is not high and the effective service cannot be obtained with the reward, or lacks the effective questioning judgment basis and “after-sales” evaluation mechanism; the poor content is spread and the website interaction is declined poorly.

### SUMMARY OF THE DISCLOSURE

An object of the disclosure is to provide a system and method for building a network platform of knowledge value-realization to solve the problem that the existing Q & A website lacks a strict and effective rating mechanism for the contents output by the user and is extremely limited for the realization of knowledge value of the user and the promotion of user activeness: the user has a low credibility; the paid Q & A process lacks the strict rule design, so that the questioner is always worried that the answer quality is not high and the effective service cannot be obtained with the reward, or lacks the effective questioning judgment basis and “after-sales” evaluation mechanism; the poor content is spread and the website interaction is declined poorly.

The disclosure is realized as the following: a method for building a network platform of knowledge value-realization, wherein the public recognition is obtained for the content rating based on the knowledge published by the user and the user rating is performed based on the user credit system on the website, to form a knowledge ranking list to fully display the user and its contribution to the knowledge content through the public rating; based on the public rating results on a user knowledge display module, the user can refer to and select forms of paying for Q & A such as reward question, invitation to answer and Q & A service to interact with other users, to achieve the market-oriented matchmaking trading and rapid realization of knowledge value.

Further, the knowledge published by the user is article/resource/Q & A; the user rating is the ability to contribute the knowledge; the knowledge ranking list is the ranking list of contents and contributors.

Another object of the disclosure is to provide a system for building a network platform of knowledge value-realization based on the method for building a network platform of knowledge value-realization, wherein the system for building a network platform of knowledge value-realization comprises:

A user knowledge display module for obtaining the public recognition for the content rating based on the knowledge published by the user and performing the user rating based on the user credit system on the website, to form a knowledge ranking list to fully display the user and its contribution to the knowledge content through the public rating;

A user knowledge value-realization module for referring to and selecting forms of paying for Q & A such as reward question, invitation to answer and Q & A service by the user to interact with other users based on the public rating results on the user knowledge display module, to achieve the market-oriented matchmaking trading and rapid realization of knowledge value.

The user knowledge display module further comprises:

A knowledge recognition unit for publishing articles, questions and answers and resources by the user on the website; the website displays the contents contributed by the user in sequence based on the public recognition through a public evaluation mechanism and incentive mechanism;

A user credit system unit for the user's contribution to the knowledge content and the interaction on the website, to form the user rating (i.e., public credibility obtained by the user) through the user credit system on the website;

A knowledge ranking list unit for obtaining the data indicators based on the public recognition of knowledge contents contributed by various users by doing statistical analysis on the website through the evaluation mechanism and incentive system; coupled with the credit rating of the user, forming a public knowledge ranking list that can be subdivided into sub-lists;

A distributed cache server, wherein the Memcached server is installed through a standalone server as a distributed cache server; for preloading the data on the ranking list page into the distributed cache server; changing the original code for taking data from the database to the code for taking directly data from the distributed cache server; when the user accesses the ranking list page, if the cache data does not expire, the data is taken directly from the cache server without need to connect to the database server, to speed up the response time of the page and reduce the data service performance cost;

A real-name authentication and qualification authentication module for uploading directly the resource files uploaded by the user in the real-name authentication and qualification authentication to a standalone static file server without an application server, and the standalone static file server has independent storage space and independent access domain name; when the user needs to browse the files, the files are downloaded directly from the static file server, and then the static resource files are placed on the CDN node for the nearest access by the user.

The real-name authentication and qualification authentication module further comprises:

A real-name authentication module:

For applying for the real-name authentication by the user on the website; after the real-name authentication of the user is completed, other users can enter the user's space to view the real-name authentication mark of the user, which can greatly enhance the user's credit on the website.

If the user applies for the real-name authentication, the user uploads the documents after logging into the website and the uploaded documents must be original and cannot be altered; after the pictures of the uploaded documents are selected, the types of the uploaded documents are also required to be selected, including ID card, passport, driver's license and pass into Hong Kong and Macao, and the real name, ID number and phone number are entered; these are required. If the information is not filled in completely, the front-end verification and back-end verification of the website page will intercept the user and prevent the user to submit the documents; after the user submits a real name application, it is required to wait for the review by the administrator and the administrator enters the website background to view the information and documents submitted by the user; after it is determined that the documents uploaded and information entered by the user are correct through the review by the administrator, the real-name authentication application of the user is opened in the background; after passing the real-name authentication review, the real-name authentication mark can be seen by entering the user's space;

Qualification authentication module:

For displaying the personal ability by uploading personal qualification certificates by the user on the website, so that other users can enter the user's space to view the user's qualification certificates, which can greatly improve the user's recognition on the website, while other users can also appreciate the qualification certificates and the user who uploads the qualification certificates can also gain more appreciation. Before uploading the qualification certificates, the user must pass the real-name authentication.

The user needs to upload the original and public version of the qualification certificate; the original is used in the review by the administrator and the public version is used to display to other users on the website.

After the user submits the qualification certificates, it is required to wait for the review by the administrator and the administrator enters the background to review the original qualification certificates submitted by the user; after passing the review by the administrator, the administrator opens the qualification certificate display permission in the background, so that other users can enter the user's space to view the user's qualification certificates;

Dynamic-static separation module:

For creating a real-name authentication static resource folder “real_name” and qualification authentication static resource folder “aptitude” on a file server built through a standalone server respectively to store the static resource files uploaded by the user and setting the corresponding read and write permissions for folders respectively;

Creating a second-level domain “user.youshizhishi.com” for the independent access to the real-name authentication and qualification authentication resource files; Directly uploading the real-name authentication and qualification authentication resource files uploaded by the user to the file server through the second-level domain “user.youshizhishi.com” rather than through the Web application server in the traditional scheme on the website;

To further improve the user's access speed and reduce the load of the Web application server, the second-level domain “user.youshizhishi.com” is accelerated by using CDN so that the source station points to the second-level domain, and to prevent other websites from stealing the resource flow, the second-level domain is configured with a security chain and access white list;

In the developed website code, the real-name authentication and qualification authentication static resource files uploaded by the user and addresses of access to these files directly use the independent second-level domain “user.youshizhishi.com”. The real-name authentication and qualification authentication module is accelerated through the dynamic and static separation technology and CDN, which not only solves the load pressure of the application server, but also greatly speeds up the user's access, so that the real-name authentication and qualification authentication function can be applied on the website well.

The user knowledge value-realization module further comprises:

A user questioning unit for asking questions by the user;

A question answering unit for answering the questions asked by the user;

An answer viewing unit for viewing the user's answers;

An evaluation system unit for evaluating the questions and answers;

A Q & A status unit for determining the status of questions and answers.

The user questioning unit further comprises:

A questioning unit for realizing the reward question, invitation to answer and Q & A service;

A reward unit for realizing the paid and unpaid reward question;

An answer limiting unit for limiting the level of users whose questions need to be answered based on the star-level users;

An urgent questioning unit for displaying the urgent questions sorted based on the price in the urgent Q & A list;

An anonymous questioning unit for protecting other users from seeing the privacy information of the questioner after anonymously asking the question; The questioning unit further comprises:

A regular questioning unit, wherein the user asks the question on the website after login, and when asking a question, the title of the question, detailed description of the question, category of the question and reward category must be filled in;

An invitation to answer unit, wherein when the user asks a regular question, up to 5 users are invited to answer the question; the user names are separated by blank spaces; after filling in the users to be invited, when the question is submitted, the website will send messages of a question to be answered to all the invited users;

A Q & A service questioning unit, wherein the user opens the Q & A service on the website and the Q & A service is equivalent to a shop of the user on the website; when setting the Q & A service, it is required to fill in the field of expertise and the main direction in the field and the price of the answer; after setting the Q & A service, other users enter the user's Q & A service to ask questions; when asking a question, the corresponding fees will be deducted from the website account of the questioner as the deposit; after the Q & A service shopkeeper answers the question, the deducted deposit will be transferred to the website account of the Q & A service shopkeeper.

The question answering unit further comprises:

An answer unit, wherein the user can select to answer the reward question in a public or non-public manner; the user can only answer the non-reward question in a public manner;

A public answer unit, wherein if the user selects to answer the question in a public manner, that is, the answerer does not need the reward of the questioner, after the question is answered, the answer will be displayed immediately and any user can see the answer, and the questioner does not need to pay the fees;

A non-public answer unit, wherein if the user selects to answer the question in a non-public manner, after the question is answered, the answer will not be displayed immediately; when the questioner or other users click to view it and after the reward for the question is paid, the answer will be displayed.

The answer viewing unit further comprises:

A public answer viewing unit, wherein it is not required to pay the reward for the public answer and the answer will be displayed by opening the detailed question page;

A non-public answer viewing unit, wherein it is required to pay the reward for the non-public answer; after the reward for the question is paid from the account, the non-public answer will be displayed only when the questioner or other users clicks it; the paid answer will be permanently displayed and other users can view it without no need to pay fees again.

The evaluation system unit further comprises:

An adoption unit that allows the user to quickly view the best answer to the question;

A scoring unit, wherein the questioner can score all answers on a scale of 1-5;

A commenting unit, wherein any login user can comment on the answer to the question and interact with the answerer;

A reporting unit, wherein if the user reports an answer to the question, after reporting, the administrator will process the answer in the background according to the actual condition;

The Q & A status unit comprises:

A pending status unit, wherein the question is pending after the user asks a question;

A resolved status unit, wherein after the questioner adopts an answer to the question, the question is changed from the pending status to the resolved status; the user may also resolve the question and can change the question status to the resolved status in the space question list;

An expired status unit, wherein if the user fails to set any answer to the question to be adopted within 10 days and also fails to change the question status to the resolved status in the Q & A management list, the question is expired;

A closed status unit, wherein the resolved and expired questions are changed to the closed status and do not accept any new answer, and the paid answer that is not viewed cannot be viewed again.

The system and method for building a network platform of knowledge value-realization according to the disclosure collects the recognition of the knowledge (articles, resources, etc.) published by the user on the website to rate the user's ability to contribute its knowledge and guide the user to accurately and reliably complete the knowledge exchange and realization through the design of various strict processes of paying for Q & A, embodied in: Through the contents output by the user on the website and the results (stars, experts and qualifications) obtained on the website, users on the website can more quickly and accurately find and understand users who have the same interests, so that the knowledge exchange can be performed between users; the recognition and trust between users are reflected by giving flowers and expressing admiration; in addition to the existing regular questions and answers, the user in the professional field can be invited quickly and accurately to answer the question through the Q & A service and invitation to answer.

Thus, a fair and effective method for building a network platform of knowledge value-realization is established. When the “person of insight” website is developed, the website operation speed, processing of the user with high concurrent access to the website, website security, stability of long-term operation of the website, costs of website development, the user's habits, etc. are considered comprehensively; the current mature Microsoft NET platform system is adopted and the main development language is C# language; meanwhile popular Web development technologies such as jQuery, Ajax, JSON and HTML5 are integrated to bring a good experience for the user. In the data storage, because there is cash transaction between users on the website, a database with good security is required to store the data and Microsoft SQL Server is used as a database with high stability and security. SQL Server can provide the highest level of availability and performance and there are many mature high performance schemes, and there are also many classic cases used in domestic large websites; therefore, SQL Server is one of the most widely used databases.

Compared with the prior art, the disclosure has the following advantages:

1 User Knowledge Display Technology Realization:

The distributed data cache technology is used to solve the problem of performance cost of the database server and excessive concurrent pressure due to the connection of the ranking list page to the database. The dynamic and static separation technology is used to upload directly the resource files uploaded by the user in the real-name authentication and qualification authentication to a standalone static file server without an application server, and the standalone static file server has independent storage space and independent access domain name; when the user needs to browse the files, the files are downloaded directly from the static file server, which greatly reduces the load pressure of the application server and the network bandwidth pressure, and then the static resource files are placed on the CDN node so that the user can achieve the nearest access, which greatly enhances the user's access speed. The asynchronous technology is used to achieve the automatic saving of contents in the editor, to solve the problem of the loss of works being written by the writers due to the power outage, computer fault or other unexpected human factors. The function of the traditional editor is enhanced; in the traditional content editor, the technologies such as JavaScript, Ajax and Html5 are used to complete the drag and drop of pictures in the editor and automatically upload pictures to the server. The experience of the user on the comment module is enhanced; in the submission and display of comments, combined with technologies such as JavaScript and Dom, Ajax technology is used to asynchronously submit and pull the data and the data pulled is dynamically added to the page to make the page data release changes without reloading the full page; the page is free of jitter and waiting, thereby enhancing the user experience.

2 User Knowledge Value-Realization Technology Realization:

To enhance the user experience, many technologies such as HTML5, JavaScript, jQuery, JSON, Ajax and Dom are used on main pages of the knowledge Q & A, so that the user's submission data and query data are asynchronous; the data pulled is dynamically added to the page by using the front-end scripting technology, so that the user's actions do not cause the data reloading and page jitter of the full page. The dynamic and static separation technology is used to directly upload the pictures uploaded in the question or answer to a standalone knowledge Q & A file server without an application server; when all users need to browse the pictures, the pictures are downloaded directly from the standalone knowledge Q & A file server, which greatly reduces the application server load pressure, storage pressure and network bandwidth pressure and enhancing the user's access speed.

3 User Knowledge Display Technology Realization:

1) Article Publishing

The user can publish an article after login; when publishing the article, the user is required to select the type of the article, the type of works, comment limit, whether there are resources to be uploaded and download limit for resources to be uploaded. The dynamic and static separation technology is used to upload directly the pictures in the article published by the user to a standalone static file server without an application server, and the standalone static file server has independent storage space and independent access domain name; when the user needs to browse the pictures, the pictures are downloaded directly from the static file server, which greatly reduces the load pressure of the application server and the network bandwidth pressure

2) Automatic Saving

To avoid the loss of the article being written by the user due to the power outage or computer fault, the automatic saving function is developed for the website and the article written by the user will be asynchronously and automatically saved to the database once every 5 minutes; to ensure that the page is not refreshed and is free of jitter and the user's writing experience is not reduced when the article is automatically saved, AJAX technology is used in the automatic saving function to achieve the asynchronous saving.

3) Temporary Saving of Articles

If the user cannot complete the article once or cannot continue to write the article due to the temporary emergency, the temporary saving function of the article is added; the article saved temporarily will not be published and will be displayed only in the article management list of the writer; when the user needs to continue to write the article, it is only required to open the article to edit and the article can be published after the completion of editing.

4) Hide/Display

The user can hide or display the published articles to achieve absolute control over its own articles.

5) Editor

The website provides the user with a traditional editor and MarkDown editor, so that the user can select its favorite editing on the setting page after login; when publishing the articles after setting, the editor selected by the user will appear. The function of the traditional editor is enhanced; in the traditional content editor, the technologies such as JavaScript, Ajax and Html5 are used to complete the drag and drop of pictures in the editor and automatically upload pictures to the server.

6) Article Display

To speed up the user to browse the contents of the article, to reduce the retrieval cost of the database server, the page output cache is used in the article display page. To ensure that the functions of the page may be reused in other pages, a large number of user controls are used, such as page header controls, page footer controls and relevant article controls, and the fragment caching is used in these controls based on the business needs of the website.

4 Resource Technology Realization

The user can upload its own works or other resources to the website to share with other users for download and use after login. The traditional upload and download are carried out in the application server, because there are many large resource files, to ensure that the file upload and download of the resource module do not affect the performance cost and network bandwidth of the application server, the resource files uploaded by the user are directly uploaded to a cloud server without an application server and the cloud server is equivalent to a standalone file server; the user who needs to download the resource files can download directly them from the cloud server by paying charges or free of charge based on the user setting, to solve the problem that the entire resource module affects the application server performance and network bandwidth. The payment information of the user is saved in the database; to ensure the rights of the user who uploads the resources, the resource data downloaded by paying charges is stored in the database; after paying charges successfully, the user can obtain the download permission for the resources.

5 Evaluation Mechanism Technology Realization

Appreciation, general, regret: to solve the huge load on the database server brought through the operation of clicking “appreciation, general, regret” by a large number of users who concurrently access to the website, in addition to the master-slave read and write separation processing of the above database server, the asynchronous technology and the queue technology are used; after the user clicks “appreciation”, the appreciations on the page are added with the front-end technology, and then the number is put into the appreciation update queue and updated from the queue to the database, so that the peak clipping processing is completed for high concurrent operation of appreciate function by a large number of users, which not only improves the throughput efficiency of the website, but also greatly accelerates the response to the user to enhance the user experience.

Comment: to quickly display the comments of the article, the article's comments are displayed in pages. The first 10 comments are loaded synchronously for the first time; if there are many comments, “more comments” button can be clicked; the data of 10 comments are pulled asynchronously from the database with AJAX technology every click, and then the pulled data is dynamically inserted into the page with JavaScript technology, so that the page is not reloaded and is free of jitter, which greatly enhances the user experience.

Resource download count: after the user downloads the resource, the download times of the resource are added and updated to the database; the user can view the download times of the resource when downloading the resource and the quality of the resource can be evaluated based on the download times.

6 Incentive Mechanism Technology Realization

The user on the website can give flowers and express admiration to the author of the article when browsing the article, with a flower for RMB 1 and an admiration for RMB 5. There are three presentation ways, such as presentation through the user's insight wallet, presentation through the Alipay and presentation through the Wechat payment. If there is balance in the user's insight wallet, the flowers can be given and the admiration can be expressed through the user's insight wallet; when the balance is insufficient, the Alipay and Wechat payment can be selected. After login, the user who receives the flowers or admiration can enter the personal space to view the received flowers and admiration and there will be a corresponding income increase in the insight wallet. To solve inconsistent transfer data in the transfer process due to possible accidents, the transaction technology is used in the process of all transfer transactions. The consistency of transaction technology can effectively guarantee the consistency of transfer transaction data.

7 Knowledge Ranking List Technology Realization

The user's knowledge and credit are displayed from different dimensions through the ranking list on the website. There are admiration ranking list, flower ranking list, points ranking list, appreciation ranking list, popular writer ranking list, productive writer ranking list, answer expert ranking list, enthusiast ranking list, adoption ranking list, article ranking list and Q & A ranking list. The data needs to be displayed on the ranking list page and needs to be pulled from dozens of data sheets in the database, and dozens of times of connection to the database is required, that is, as long as there is a user to access the ranking list page, more than ten times of connection to the database server on the website is required and the data is pulled from dozens of data sheets, which increases the performance cost of the database and even leads to the database server downtime. To solve the pressure problem of the knowledge ranking list on the database server, the distributed cache technology is used. Based on the business needs on the website, the data of various dimensions of the ranking list is cached in the server memory and the appropriate expiration time is specified. When a user accesses the ranking list page, the data is pulled directly from the cache server memory, without need to access the database. Only after the data of a dimension of the ranking list is expired, the connection to the database is required and the data is pulled from the database, which greatly reduces the times of page access to the database, reducing the pressure on the database server.

8 User Credit System

The user is required to upload the static resource files for the most important real-name authentication and qualification authentication in the user credit system. The resource files uploaded by the user not only affect the application server storage space and network bandwidth, but also greatly reduce the performance of the server. To solve the problem that the real-name authentication and qualification authentication do not affect the performance of the application server, the dynamic and static separation and CDN acceleration technologies are used on the “person of insight” website. Lots of resource files uploaded by the user are directly stored in a standalone file server for management through an independent domain name. These resource files are directly stored in a standalone file server without an application server. And then the static resources on the file server are placed on the CDN for acceleration; CDN distributes these static resources to the node servers across the country, that is, these static resources are deployed in the network service providers nearest to the user, so that the user will use the nearest access principle when accessing to these files, without need to access to the source file server, which reduces the load pressure on the Web application server when uploading the resources and greatly enhance the user's access speed, and also solves the problem of communication between the north and south in China due to the nearest access principle.

9 User Knowledge Value-Realization Technology Realization:

1) Paying for Q & A

The user can login into the website to ask questions and there are two main ways:

Regular questioning (including the invitation to answer); there are some options that can be selected based on the questioner's own situation: the questioner can select whether to ask questions urgently; if the questioner selects to ask questions urgently, RMB 1 is required to be paid to the website. The questioner can select whether to ask questions anonymously; if the questioner selects to ask questions anonymously, any information about the questioner will not be displayed on the question display page. The questioner can select whether to ask questions by offering a reward; when the questioning is completed, the system will temporarily deduct the reward amount set by the user when asking questions, and after the questioner views a user's non-public answer, the system will transfer the reward amount deducted temporarily to the wallet of the answerer. The questioner can select whether there is the answer limit and the low star level user can be limited to answer questions based on the limit. The questioner can select whether to invite other users to answer questions; if there are users invited, after asking questions, the website will send messages to all the invited users.

Q & A service; the Q & A service is equivalent to the Q & A shop on the website. After the user sets its own fields of expertise and answer pricing, other users can enter the user's space to ask him (her) questions. After the questions are asked, the deposit of answer pricing is charged. After the user answers questions, the deposit charged is transferred to the wallet of the answerer on the website.

To provide the questioner with a better experience, the technologies such as HTML5, JavaScript and Ajax are used in the questioning editor to increase the drag and drop function of pictures and the automatic upload function of pictures to the server.

The dynamic and static separation structure is used on the website, so that the user can directly upload the pictures uploaded by the user when asking questions to a standalone questioning resource file server without an application server; when the user browses the questions, the pictures can also be read directly from the file server, which greatly reduces the application server performance and the network bandwidth cost, so that the questioning page can respond quickly to the user's request.

2) Question Answering Technology Realization

When the user answers the question, the website will check the user's login status. If the user does not login into the website, the login window will pop up to allow the user to log in and answer the question after login. When answering the question, the user can select to answer the question in a public or non-public manner. If the public answer is selected, the answer will be displayed immediately after answering the question and all users can view the answer. If the non-public answer is selected, the answer will not be displayed immediately and can be displayed after the questioner or other users pay the reward amount set by the questioner when asking the question. After the user views the non-public answer, the money in the wallets of the questioner and the answerer will be added and subtracted correspondingly based on the reward amount. When the user answers the question, the website will check whether the questioner has set the star level limit; if there is a limit, the answerer's star level will be pulled, and then two star levels are compared. If the answerer's star level is higher than the limited star level, the answer can be submitted; otherwise, the answer is submitted unsuccessfully.

3) Answer Viewing Technology Realization

The user can view the answer in two ways. One is public answer; the answer will be displayed by opening the page directly and all users can view the answer. The other is non-public answer; the answer will not be displayed immediately and can be displayed after the questioner or other users pay the reward amount set by the questioner when asking the question. After the user views the non-public answer, the money in the wallets of the questioner and the answerer will be added and subtracted correspondingly based on the reward amount. Confidentiality of the user's non-public answer content: the user's non-public answer content is not saved in the page when loading the page. The display of answer content is controlled with the style on the page, so that the experienced user can view the answer content through the source code of the browser. Only when the user pays the reward fee and the transaction between the questioner and the answerer is completed successfully, the answer content is pulled from the database by using the asynchronous technology, and then the pulled answer content is dynamically inserted into the page for display with JavaScript, Ajax and Dom technologies.

4) Answer Evaluation System Technology Realization

Answer Adoption

When viewing the answer, the questioner can adopt the best answer and the adopted answer will be arranged in front of all answers, so that other users can quickly find the best answer. To ensure that the changes in status of the answer content do not affect the user experience, the data is pulled asynchronously for the answer page and the page is refreshed locally, to enhance the user experience.

Answer Commenting

The user can comment on all answers that display the content. The questioner can interact with the answerer or other users through the comment function. When the traditional comments are loaded on the page, the comments are taken from the database once, which takes a large number of comments that the browser is not concerned about so that the page is too cluttered, and greatly costs the performance of the application server and database service. To ensure that the page has a clear display (the answer weight is important and the comment weight is lesser) and reduce the performance cost of the server, AJAX technology is used to asynchronously obtain the data as needed and JavaScript and Dom technologies are used to dynamically add the data to the page.

Scoring; the questioner can score all answers that display the content. To ensure that the submission of data does not affect the user experience on the page when scoring, the asynchronous technology, JavaScript and Dom technologies are used.

Reporting; the browser can report the answer content. The report button is not displayed when loading the page; only after the browser moves the mouse to the answer content, the report button is displayed. To provide a good reporting function experience for the user, the small window is dynamically loaded by using a mask to allow the user to report illegal answer contents.

10 Q & A Status Technology Realization

The questioning cycle is set to four statuses: pending status, resolved status, expired status and closed status. When the question is submitted, the question is in the pending status at this time; after the user solves the question or adopts the answer of other users to solve the question, the question status becomes the resolved status; if the answer of other users do not help solve the question within 10 days and the questioner also does not solve the question, the question status becomes the expired status at this time and the website will automatically check the question status and make the appropriate changes. The question status is automatically checked and the appropriate changes are made by using the database stored procedure technology and operation scheduling technology. The business logic that checks and changes the Q & A status is written in the database stored procedure and placed on the database server. And then the change in the Q & A expiration status and deposit returning operation are completed during the scheduling of stored procedures in the morning of every day by using the data operation function.

11 Comprehensive Knowledge Rating Design (Knowledge Contribution Ability Display):

The investigation and anticipation of the user knowledge background and contribution ability can be as comprehensive and accurate as possible, so that the user (and knowledge output by the user) is very credible, to solve the trust issue and maintain the credibility of the website.

12 Strict Q & A Rule Design (Fair and Effective Knowledge Value-Realization):

There is a Q & A feedback mechanism (adoption and scoring) and it has an effect of “rewarding good performance and punishing poor performance” on the user and an effect of “survival of the fittest” on the knowledge and there is the star level setting function (the questioner can control the level of participants), to effectively guide the output of high-quality content; there are three payment modes (offering a reward, invitation to answer and Q & A service) to achieve the market-oriented matchmaking trading of knowledge value and solve the problem of rapid realization through free pricing, fair trading and payment guarantee (the answer to be paid can be viewed only after the reward is paid).

### BRIEF DESCRIPTION OF THE DRAWINGS

FIG. 1 is a structural schematic diagram of the system for building a network platform of knowledge value-realization according to an embodiment of the disclosure;

FIG. 2 is a process diagram of the knowledge value-realization according to an embodiment of the disclosure;

In figures: 1. user knowledge display module; 2. user knowledge value-realization module.

### DETAILED DESCRIPTION OF THE PREFERRED EMBODIMENTS

The disclosure will now be described in detail with reference to the embodiments to more clearly clarify the purpose, technical solution and advantages of the disclosure. It should be understood that the preferred embodiments described herein are only to explain the disclosure and are not intended to limit the disclosure.

According to the disclosure, the public recognition is obtained for the content rating based on the knowledge (article/resource/Q & A) published by the user and the user rating (knowledge contribution ability) is performed based on the “user credit system” on the website, to form a knowledge (content and the contributor) ranking list to fully display the user and its contribution to the knowledge content (article/resource/Q & A) through the public rating; The user can refer to and select three forms of paying for Q & A (reward question, invitation to answer and Q & A service) to interact with other users based on the public rating results on the user knowledge display module, to achieve the market-oriented matchmaking trading and rapid realization of knowledge value.

In combination with the attached drawings, the following contents provide the application principle of the disclosure in detail.

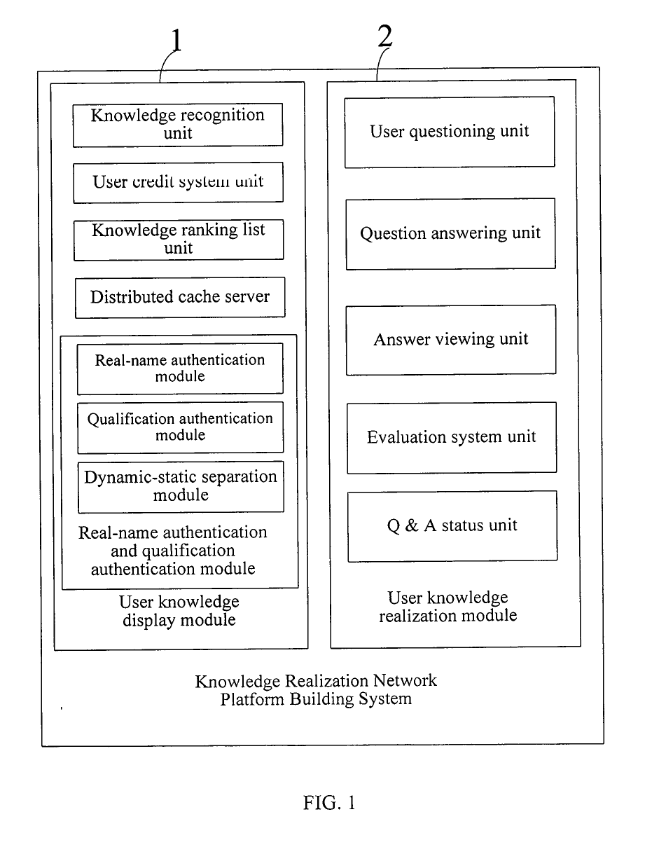

As shown in FIG. 1, the system for building a network platform of knowledge value-realization according to an embodiment of the disclosure comprises a user knowledge display module 1 and a user knowledge value-realization module 2.

A user knowledge display module 1, wherein the public recognition is obtained for the content rating based on the knowledge (article/resource/Q & A) published by the user and the user rating (knowledge contribution ability) is performed based on the “user credit system” on the website, to form a knowledge (content and the contributor) ranking list to fully display the user and its contribution to the knowledge content (article/resource/Q & A) through the public rating.

A user knowledge value-realization module 2, wherein the user can refer to and select three forms of paying for Q & A (reward question, invitation to answer and Q & A service) to interact with other users based on the public rating results on the user knowledge display module, to achieve the market-oriented matchmaking trading and rapid realization of knowledge value.

The User Knowledge Display Module 1 Comprises:

A knowledge recognition unit, wherein the user can publish the articles, questions and answers (subdivided into 36 knowledge areas) and resources (free or paid attachment download form) on the “person of insight” website. The website displays the contents contributed by the user in sequence based on the public recognition through the public evaluation mechanism (appreciation/general/regret similar to “favorable comment, medium comment and negative comment”; comment/download times; answer adoption rate/applause rate) and incentive mechanism (flowers/admiration similar to the “reward” function).

A user credit system unit, wherein the user's contribution to the knowledge content and the interaction (i.e., comment) on the “person of insight” website form the user rating (knowledge contribution ability), that is, the public credibility obtained by the user, through the user credit system (star level setting, integration rule and qualification authentication) on the website. The star level on the website is divided into ordinary star level, authoritative star level and expert star level.

Before passing the qualification authentication, the user must pass the real-name authentication. After passing the real-name authentication (and a point is reached), the user can be upgraded to the authoritative star level; after passing the qualification authentication (and a point is reached), the user can be upgraded to the expert star level.

A knowledge ranking list unit, wherein the data indicators of the public recognition are obtained by doing statistical analysis of knowledge contents (article/resource/Q & A) contributed by various users through the evaluation mechanism (appreciation/general/regret, comment/download times and answer adoption rate/applause rate) and incentive mechanism (number of flowers/admiration); coupled with the credit rating of the user, a public knowledge (specific content/the contributor) ranking list is formed and can be subdivided into article, resource, Q & A and user sub-lists for public reference.

In the knowledge ranking list (and even the whole “user knowledge display” module), the user ranking (knowledge contribution ability) is the core and the rating of knowledge contents (article/resource/Q & A) is used ultimately to display the knowledge level of the contributor. A prerequisite problem of the knowledge output user (namely, the contributor) and its content credibility is solved to specifically achieve the knowledge value-realization, thus laying a foundation.

A distributed cache server, wherein the Memcached server is installed through a standalone server as a distributed cache server; for preloading the data on the ranking list page into the distributed cache server; changing the original code for taking data from the database to the code for taking directly data from the distributed cache server; when the user accesses the ranking list page, if the cache data does not expire, the data is taken directly from the cache server without need to connect to the database server, to speed up the response time of the page and reduce the data service performance cost;

A real-name authentication and qualification authentication module for uploading directly the resource files uploaded by the user in the real-name authentication and qualification authentication to a standalone static file server without an application server, and the standalone static file server has independent storage space and independent access domain name; when the user needs to browse the files, the files are downloaded directly from the static file server, and then the static resource files are placed on the CDN node for the nearest access by the user.

The Real-Name Authentication and Qualification Authentication Module Comprises:

A Real-Name Authentication Module:

For applying for the real-name authentication by the user on the website; after the real-name authentication of the user is completed, other users can enter the user's space to view the real-name authentication mark of the user, which can greatly enhance the user's credit on the website.

If the user applies for the real-name authentication, the user uploads the documents after logging into the website and the uploaded documents must be original and cannot be altered; after the pictures of the uploaded documents are selected, the types of the uploaded documents are also required to be selected, including ID card, passport, driver's license and pass into Hong Kong and Macao, and the real name, ID number and phone number are entered; these are required. If the information is not filled in completely, the front-end verification and back-end verification of the website page will intercept the user and prevent the user to submit the documents; after the user submits a real name application, it is required to wait for the review by the administrator and the administrator enters the website background to view the information and documents submitted by the user; after it is determined that the documents uploaded and information entered by the user are correct through the review by the administrator, the real-name authentication application of the user is opened in the background; after passing the real-name authentication review, the real-name authentication mark can be seen by entering the user's space;

Qualification Authentication Module:

For displaying the personal ability by uploading personal qualification certificates by the user on the website, so that other users can enter the user's space to view the user's qualification certificates, which can greatly improve the user's recognition on the website, while other users can also appreciate the qualification certificates and the user who uploads the qualification certificates can also gain more appreciation. Before uploading the qualification certificates, the user must pass the real-name authentication.

The user needs to upload the original and public version of the qualification certificate; the original is used in the review by the administrator and the public version is used to display to other users on the website.

After the user submits the qualification certificates, it is required to wait for the review by the administrator and the administrator enters the background to review the original qualification certificates submitted by the user; after passing the review by the administrator, the administrator opens the qualification certificate display permission in the background, so that other users can enter the user's space to view the user's qualification certificates;

Dynamic-Static Separation Module:

For creating a real-name authentication static resource folder “real_name” and qualification authentication static resource folder “aptitude” on a file server built through a standalone server respectively to store the static resource files uploaded by the user and setting the corresponding read and write permissions for folders respectively;

Creating a second-level domain “user.youshizhishi.com” for the independent access to the real-name authentication and qualification authentication resource files; Directly uploading the real-name authentication and qualification authentication resource files uploaded by the user to the file server through the second-level domain “user.youshizhishi.com” rather than through the Web application server in the traditional scheme on the website;

To further improve the user's access speed and reduce the load of the Web application server, the second-level domain “user.youshizhishi.com” is accelerated by using CDN so that the source station points to the second-level domain, and to prevent other websites from stealing the resource flow, the second-level domain is configured with a security chain and access white list;

In the developed website code, the real-name authentication and qualification authentication static resource files uploaded by the user and addresses of access to these files directly use the independent second-level domain “user.youshizhishi.com”. The real-name authentication and qualification authentication module is accelerated through the dynamic and static separation technology and CDN, which not only solves the load pressure of the application server, but also greatly speeds up the user's access, so that the real-name authentication and qualification authentication function can be applied on the website well.

The user knowledge value-realization module 2 comprises:

A user questioning unit for asking questions by the user.

A question answering unit for answering the questions asked by the user.

An answer viewing unit for viewing the user's answers.

An evaluation system unit for evaluating the questions and answers.

A Q & A status unit for determining the status of questions and answers.

The user questioning unit comprises:

A questioning unit, wherein there are three forms: reward question (regular question), invitation to answer and Q & A service;

A regular questioning unit, wherein the user asks the question on the website after login, and when asking a question, the title of the question, detailed description of the question, category of the question and reward category must be filled in. The detailed description of the question is filled in to allow other users to better understand the question and improve the quality of the answer; the category of the question is filled in to classify questions, so that users with the same interest can quickly browse the question.

An invitation to answer unit, wherein when the user asks a regular question, up to 5 users are invited to answer the question; the user names are separated by blank spaces; after filling in the users to be invited, when the question is submitted, the website will send messages of a question to be answered to all the invited users.

A Q & A service questioning unit, wherein the user can open the Q & A service on the website and the Q & A service is equivalent to a shop of the user on the website. The user can set some fields of expertise in the Q & A service to sell the answer. When setting the Q & A service, it is required to fill in the field of expertise and the main direction in the field and the price of the answer After setting the Q & A service, other users can enter the user's Q & A service to ask the question; when asking a question, the corresponding fees will be deducted from the website account of the questioner as the deposit; after the Q & A service shopkeeper answers the question, the deducted deposit will be transferred to the website account of the Q & A service shopkeeper. If the Q & A service shopkeeper fails to answer the question after 10 days, the deducted deposit will be returned to the website account of the questioner.

A reward unit, wherein there are two types of reward: 1. Free of charge, both the questioner and the answerer cannot obtain the charges; 2. Paying charges, the currency (RMB) is paid as the reward; by default, the free of charge is selected for the website system; when the user selects to offer the reward in RMB, the amount ranging from RMB 1100 can be filled in. When the user submits the question, the system will check whether there is enough reward amount in the questioner's account. If the amount is insufficient, the user will be prompted to turn to the recharge page for recharge; if the amount is sufficient, the system will temporarily deduct the amount filled in as the deposit. If the user does not view the non-public answer within 10 days, the system will automatically return the deposit to the user's website account.

An answer limiting unit, wherein the answer limiting is optional; by default, the answerer is not limited on the website and the user can also limit the answerer level based on the star level.

An urgent questioning unit, wherein the urgent questioning is optional; by default, the question is not asked urgently on the website. If the user ask the question urgently, the question will be displayed in the urgent Q & A list and sorted based on the price with the display time of 10 days.

An anonymous questioning unit, wherein the anonymous questioning is optional; by default, the question is not asked anonymously on the website. The user can select to ask the question anonymously; after anonymously asking the question, other users cannot view any information of the questioner, such as head portrait, name, etc., for protecting the privacy of the questioner.

The question answering unit comprises:

An answer unit, wherein the user can select to answer the reward question in a public or non-public manner; the user can only answer the non-reward question in a public manner.

A public answer unit, wherein if the user selects to answer the question in a public manner, that is, the answerer does not need the reward of the questioner, after the question is answered, the answer will be displayed immediately and any user can see the answer, and the questioner does not need to pay the fees.

A non-public answer unit, wherein if the user selects to answer the question in a non-public manner, after the question is answered, the answer will not be displayed immediately; when the questioner or other users click to view it and after the reward for the question is paid (to the answerer), the answer will be displayed.

The answer viewing unit comprises:

A public answer viewing unit, wherein it is not required to pay the reward for the public answer and the answer will be displayed by opening the detailed question page.

A non-public answer viewing unit, wherein it is required to pay the reward for the non-public answer; after the reward for the question is paid from the account, the non-public answer will be displayed only when the questioner or other users clicks it; the paid answer will be permanently displayed and other users can view it without no need to pay fees again.

An evaluation system unit, wherein there are the following four Q & A evaluation systems on the Q & A module:

An adoption unit, wherein the questioner can pick out the best answer from answers of other users. The adopted answer will be arranged in front of all answers, so that the browser can quickly find the best answer of the question.

A scoring unit, wherein the questioner can score all answers on a scale of 1-5.

A commenting unit, wherein any login user can comment on the answer to the question and interact with the answerer.

A reporting unit, wherein if the user reports an answer to the question, after reporting, the administrator will process the answer in the background according to the actual condition.

A Q & A status unit, wherein there are four questioning statuses: pending, resolved, expired and closed.

A pending status unit, wherein the question is pending after the user asks a question.

A resolved status unit, wherein after the questioner adopts an answer to the question, the question is changed from the “pending” status to the “resolved” status; the user may also resolve the question and can change the question status to the “resolved” status in the space question list.

An expired status unit, wherein if the user fails to set any answer to the question to be adopted within 10 days (the best answer is not obtained) and also fails to change the question status to the resolved status in the Q & A management list (the user does not resolve the question), the question is expired. For all expired questions, the website will check whether the questioner has paid to view the answer; if the questioner views the paid answer, the deposit will be paid to the answerer; if the questioner does not view any paid answer within 10 days, the deposit will be returned to the website account of the questioner.

A closed status unit, wherein the resolved and expired questions are changed to the closed status and do not accept any new answer, and the paid answer that is not viewed cannot be viewed again.

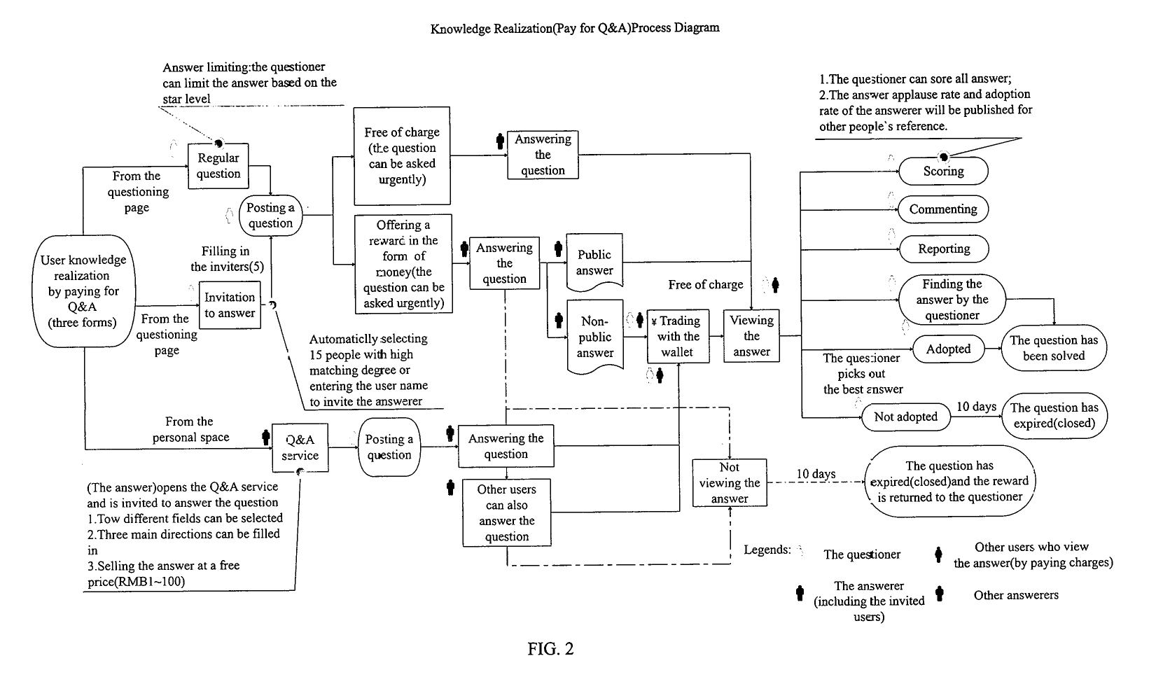

As shown in FIG. 2, the user can ask the regular question after login and the questioner can limit the answerer based on the star level. When asking a regular question, the user can invite users who login into the website from the questioning page to answer the question; up to 5 users are invited to answer the question. The user names are separated by blank spaces; after filling in the users to be invited, when the question is submitted, the website will send messages of a question to be answered to all the invited users. After posting a question, the user who asks the regular question and invites other users to answer the question can offer a reward for the question. There are two types of reward: free of charge, both the questioner and the answerer cannot obtain the charges; paying charges, the currency (RMB) is paid as the reward. The user can select to answer the reward question in a public or non-public manner; the user can only answer the non-reward question in a public manner. If the user selects to answer the question in a public manner, that is, the answerer does not need the reward of the questioner, after the question is answered, the answer will be displayed immediately and any user can see the answer, and the questioner does not need to pay the fees. If the user selects to answer the question in a non-public manner, after the question is answered, the answer will not be displayed immediately; when the questioner or other users click to view it and after the reward for the question is paid (to the answerer), the answer will be displayed. Finally, the above Q & A process is provided with an evaluation system and four rating systems, such as adoption, scoring, commenting and reporting. After the adoption, the questioner can pick out the best answer from answers of other users and the adopted answer will be arranged in front of all answers, so that the browser can quickly find the best answer of the question. During scoring, the questioner can score all answers on a scale of 1-5. During commenting, any login user can comment on the answer to the question and interact with the answerer. During reporting, the user can report an answer to the question; after reporting, the administrator will process the answer in the background according to the actual condition.

In addition, there are four questioning statuses of pending, resolved, expired and closed; the question is pending after the user asks a question. After the questioner adopts an answer to the question, the question is changed from the “pending” status to the “resolved” status; the user may also resolve the question and can change the question status to the “resolved” status in the space question list. If the user fails to set any answer to the question to be adopted within 10 days (the best answer is not obtained) and also fails to change the question status to the resolved status in the Q & A management list (the user does not resolve the question), the question is expired. The resolved and expired questions are changed to the closed status and do not accept any new answer, and the paid answer that is not viewed cannot be viewed again.

Moreover, the user can also enter the website from the personal space to open the Q & A service. (The answerer) opens the Q & A service and is invited to answer the question. The answerer can select two different fields and three main directions and sells the answer at a free price from RMB 1100. After setting the Q & A service, other users can enter the user's Q & A service to ask the question; when asking a question, the corresponding fees will be deducted from the website account of the questioner as the deposit; after the Q & A service shopkeeper answers the question, the deducted deposit will be transferred to the website account of the Q & A service shopkeeper. If the Q & A service shopkeeper fails to answer the question after 10 days, the deducted deposit will be returned to the website account of the questioner.

When the user asks a question, the title of the question, detailed description of the question, category of the question and reward category must be filled in, to allow other users to better understand the question and improve the quality of the answer; the category of the question is filled in to classify questions, so that users with the same interest can quickly browse the question. During posting a question, the free of charge is selected for the website system by default; when the user selects to offer the reward in RMB, the amount ranging from RMB 1100 can be filled in. When the user submits the question, the system will check whether there is enough reward amount in the questioner's account. If the amount is insufficient, the user will be prompted to turn to the recharge page for recharge; if the amount is sufficient, the system will temporarily deduct the amount filled in as the deposit. If the user does not view the non-public answer within 10 days, the system will automatically return the deposit to the user's website account.

As described above, the network platform of knowledge value-realization according to the disclosure is specifically built through two modules of the “user knowledge display module (three public rating forms: knowledge recognition, user credit system and knowledge ranking list)” and “user knowledge value-realization module (three forms of paying for Q & A: reward question, invitation to answer and Q & A service)”:

| Design feature | Specific display | Results | Causality analysis |
|---|---|---|---|
| Comprehensive knowledge | 1. Knowledge | The investigation | 1. The comprehensive indicators of |
| rating design | (article/resource/Q & A) | and anticipation of | “appreciation” number, number of |
| (knowledge contribution | recognition (appreciation | the user knowledge | comments and applause rate of other |
| ability display) | number, | background and | users are obtained, which means that |
| | comment/download times, | contribution ability | the user's knowledge and ability need |
| | answer adoption | can be as | to be publicly recognized |
| | rate/applause rate and other | comprehensive and | 2. The credit system (star level, |
| | evaluation mechanisms); | accurate as possible | points and qualification) rating is the |
| | 2. User credit system (star | so that the user (and | effective mapping of the user |
| | level setting, integration | knowledge output | professionalism and credibility, thus |
| | rule and qualification | by the user) is very | effectively guaranteeing the authority |
| | authentication); | credible, to solve | of the user level and stimulating the |
| | 3. Knowledge (content/the | the trust issue and | user to make efforts to a higher level |
| | contributor) ranking list. | maintain the | of “honor” . |
| | | credibility of the | 3. The ranking list is the concentrated |
| | | website. | reflection of the user and value of |
| | | | contribution content and ultimately |
| | | | reflects the user's activeness and |
| | | | knowledge contribution ability, and |
| | | | also provides an important reference |
| | | | basis to allow the public ask high |
| | | | level of knowledgeable people for |
| | | | help. |
| Strict Q & A role design | General Q & A principle: | 1. There is a Q & A | 1. Freedom of realization process |
| (fair and effective | When viewing the | feedback | The questioner has the right to set the |
| knowledge | non-public answer (to be | mechanism | user who participates in the answer to |
| value-realization) | paid) of the answerer, the | (adoption and | the question based on the star level |
| | questioner must offer a | scoring) and it has | and can also select the specific |
| | reward; meanwhile, the | an effect of | answerer; the answerer can also |
| | questioner has the right to | “rewarding good | select the free pricing and the |
| | score all answers, (pick out | performance and | questioner through the personalized |
| | the best answer) and adopt | punishing poor | Q & A service. |
| | it, and the data will be | performance” on the | 2. Security of realization process |
| | published for other people's | user and an effect of | When viewing the non-public answer |
| | reference. | “survival of the | (to be paid) of the answerer, the |
| | Features of paying for Q & | fittest” on the | questioner must offer a reward (the |
| | A: | knowledge and | reward is transferred to the website |
| | 1. General question | there is the star | platform as the deposit; after the |
| | (reward); in addition to free | level setting | questioner actually views the answer, |
| | pricing (offering a reward), | function (the | the reward is offered really. If the |
| | the questioner can set the | questioner can | questioner does not view the answer |
| | user who participates in the | control the level of | within 10 days, the platform will |
| | answer to the question | participants), to | automatically return the deposit); |
| | based on the star level; | effectively guide the | therefore, the answerer does not have |
| | 2. Invitation to answer; the | output of | to worry that the reasonable reward |
| | questioner can select the | high-quality content | cannot be obtained in a timely |
| | particular group of | 2. There are three | manner after answering the question |
| | answerers based on the | payment modes | (the questioner has viewed the |
| | user's knowledge display; | (offering a reward, | answer). |
| | 3. Q & A service; the | invitation to answer | 3. Fairness of realization process |
| | questioner can select the | and Q & A service) | The questioner has the right to score |
| | personalized service and | to achieve the | all answers, (pick out the best |
| | free pricing of the answerer. | market-oriented | answer) and adopt it. The |
| | | matchmaking | “after-sales” evaluation and feedback |
| | | trading of | mechanism effectively guarantees the |
| | | knowledge value | fairness of realization transaction, so |
| | | and solve the | that the questioner does not have to |
| | | problem of rapid | worry that the answer quality is not |
| | | realization through | high and the effective service cannot |
| | | free pricing, fair | be obtained even though the reward |
| | | trading and payment | has been offered, and encourages the |
| | | guarantee (the | output of high-quality content. |
| | | answer to be paid | |
| | | can be viewed only | |
| | | after the reward is | |
| | | paid). | |

Although the disclosure has been illustrated and described herein with reference to preferred embodiments, it should not be construed as limiting the scope of the disclosure. Any modifications, equivalent substitutions and improvements that are within the spirit and principle of the disclosure are intended to be covered by the protection scope of the disclosure.

1. A method for building a network platform of knowledge value-realization, wherein the public recognition is obtained for the content rating based on the knowledge published by the user and the user rating is performed based on the user credit system on the website, to form a knowledge ranking list to fully display the user and its contribution to the knowledge content through the public rating; based on the public rating results on a user knowledge display module, the user can refer to and select forms of paying for Q & A such as reward question, invitation to answer and Q & A service to interact with other users, to achieve the market-oriented matchmaking trading and rapid realization of knowledge value.

2. The method for building a network platform of knowledge value-realization according to claim 1, wherein the knowledge published by the user is article/resource/Q & A; the user rating is the ability to contribute the knowledge; the knowledge ranking list is the ranking list of contents and contributors.

3. A system for building a network platform of knowledge value-realization based on the method for building a network platform of knowledge value-realization according to claim 1, wherein the system for building a network platform of knowledge value-realization comprises:
A user knowledge display module for obtaining the public recognition for the content rating based on the knowledge published by the user and performing the user rating based on the user credit system on the website, to form a knowledge ranking list to fully display the user and its contribution to the knowledge content through the public rating;
A user knowledge value-realization module for referring to and selecting forms of paying for Q & A such as reward question, invitation to answer and Q & A service by the user to interact with other users based on the public rating results on the user knowledge display module, to achieve the market-oriented matchmaking trading and rapid realization of knowledge value.

4. The system for building a network platform of knowledge value-realization according to claim 3, wherein the user knowledge display module comprises:
A knowledge recognition unit for publishing articles, questions and answers and resources by the user on the website; the website displays the contents contributed by the user in sequence based on the public recognition through a public evaluation mechanism and incentive mechanism;
A user credit system unit for the user's contribution to the knowledge content and the interaction on the website, to form the user rating (i.e., public credibility obtained by the user) through the user credit system on the website;
A knowledge ranking list unit for obtaining the data indicators based on the public recognition of knowledge contents contributed by various users by doing statistical analysis on the website through the evaluation mechanism and incentive system;
coupled with the credit rating of the user, forming a public knowledge ranking list that can be subdivided into sub-lists;
A distributed cache server, wherein the Memcached server is installed through a standalone server as a distributed cache server; for preloading the data on the ranking list page into the distributed cache server; changing the original code for taking data from the database to the code for taking directly data from the distributed cache server; when the user accesses the ranking list page, if the cache data does not expire, the data is taken directly from the cache server without need to connect to the database server, to speed up the response time of the page and reduce the data service performance cost;
A real-name authentication and qualification authentication module for uploading directly the resource files uploaded by the user in the real-name authentication and qualification authentication to a standalone static file server without an application server, and the standalone static file server has independent storage space and independent access domain name; when the user needs to browse the files, the files are downloaded directly from the static file server, and then the static resource files are placed on the CDN node for the nearest access by the user.

5. The system for building a network platform of knowledge value-realization according to claim 4, wherein the real-name authentication and qualification authentication module comprises:
A real-name authentication module:
For applying for the real-name authentication by the user on the website; the user uploads the documents after logging into the website and the uploaded documents must be original and cannot be altered; after the pictures of the uploaded documents are selected, the types of the uploaded documents are also required to be selected, including ID card, passport, driver's license and pass into Hong Kong and Macao, and the real_name, ID number and phone number are entered; if the information is not filled in completely, the front-end verification and back-end verification of the website page will intercept the user and prevent the user to submit the documents; after the user submits a real_name application, it is required to wait for the review by the administrator and the administrator enters the website background to view the information and documents submitted by the user; after it is determined that the documents uploaded and information entered by the user are correct through the review by the administrator, the real-name authentication application of the user is opened in the background; after passing the real-name authentication review, the real-name authentication mark can be seen by entering the user's space;
Qualification authentication module:
For displaying the personal ability by uploading personal qualification certificates by the user on the website, so that other users can enter the user's space to view the user's qualification certificates, while other users can also appreciate the qualification certificates; after the user submits the qualification certificates, it is required to wait for the review by the administrator and the administrator enters the background to review the original qualification certificates submitted by the user; after passing the review by the administrator, the administrator opens the qualification certificate display permission in the background, so that other users can enter the user's space to view the user's qualification certificates;
Dynamic-static separation module:
For creating a real-name authentication static resource folder and qualification authentication static resource folder on a file server built through a standalone server respectively and setting the corresponding read and write permissions for folders respectively; creating a second-level domain for the independent access to the real-name authentication and qualification authentication resource files; directly uploading the real-name authentication and qualification authentication resource files uploaded by the user to the file server through the second-level domain on the website; the second-level domain is accelerated by using CDN so that the source station points to the second-level domain, and the second-level domain is configured with a security chain and access white list; in the developed website code, the real-name authentication and qualification authentication static resource files uploaded by the user and addresses of access to these files directly use the independent second-level domain.

6. The system for building a network platform of knowledge value-realization according to claim 3, wherein the user knowledge value-realization module comprises:
A user questioning unit for asking questions by the user;
A question answering unit for answering the questions asked by the user;
An answer viewing unit for viewing the user's answers;
An evaluation system unit for evaluating the questions and answers;
A Q & A status unit for determining the status of questions and answers.

7. The system for building a network platform of knowledge value-realization according to claim 6, wherein the user questioning unit comprises:
A questioning unit for realizing the reward question, invitation to answer and Q & A service;
A reward unit for realizing the paid and unpaid reward question;
An answer limiting unit for limiting the level of users whose questions need to be answered based on the star-level users;
An urgent questioning unit for displaying the urgent questions sorted based on the price in the urgent Q & A list;
An anonymous questioning unit for protecting other users from seeing the privacy information of the questioner after anonymously asking the question.

8. The system for building a network platform of knowledge value-realization according to claim 7, wherein the questioning unit comprises:
A regular questioning unit, wherein the user asks the question on the website after login, and when asking a question, the title of the question, detailed description of the question, category of the question and reward category must be filled in;
An invitation to answer unit, wherein when the user asks a regular question, up to 5 users are invited to answer the question; the user names are separated by blank spaces; after filling in the users to be invited, when the question is submitted, the website will send messages of a question to be answered to all the invited users;
A Q & A service questioning unit, wherein the user opens the Q & A service on the website and the Q & A service is equivalent to a shop of the user on the website; when setting the Q & A service, it is required to fill in the field of expertise and the main direction in the field and the price of the answer; after setting the Q & A service, other users enter the user's Q & A service to ask questions; when asking a question, the corresponding fees will be deducted from the website account of the questioner as the deposit; after the Q & A service shopkeeper answers the question, the deducted deposit will be transferred to the website account of the Q & A service shopkeeper.

9. The system for building a network platform of knowledge value-realization according to claim 6, wherein the question answering unit comprises:
An answer unit, wherein the user can select to answer the reward question in a public or non-public manner; the user can only answer the non-reward question in a public manner;
A public answer unit, wherein if the user selects to answer the question in a public manner, that is, the answerer does not need the reward of the questioner, after the question is answered, the answer will be displayed immediately and any user can see the answer, and the questioner does not need to pay the fees;
A non-public answer unit, wherein if the user selects to answer the question in a non-public manner, after the question is answered, the answer will not be displayed immediately; when the questioner or other users click to view it and after the reward for the question is paid, the answer will be displayed;
The answer viewing unit comprises:
A public answer viewing unit, wherein it is not required to pay the reward for the public answer and the answer will be displayed by opening the detailed question page;
A non-public answer viewing unit, wherein it is required to pay the reward for the non-public answer; after the reward for the question is paid from the account, the non-public answer will be displayed only when the questioner or other users clicks it;
the paid answer will be permanently displayed and other users can view it without no need to pay fees again.

10. The system for building a network platform of knowledge value-realization according to claim 6, wherein the evaluation system unit comprises:
An adoption unit that allows the user to quickly view the best answer to the question;
A scoring unit, wherein the questioner can score all answers on a scale of 1-5;
A commenting unit, wherein any login user can comment on the answer to the question and interact with the answerer;
A reporting unit, wherein if the user reports an answer to the question, after reporting, the administrator will process the answer in the background according to the actual condition;
The Q & A status unit comprises:
A pending status unit, wherein the question is pending after the user asks a question;
A resolved status unit, wherein after the questioner adopts an answer to the question, the question is changed from the pending status to the resolved status; the user may also resolve the question and can change the question status to the resolved status in the space question list;
An expired status unit, wherein if the user fails to set any answer to the question to be adopted within 10 days and also fails to change the question status to the resolved status in the Q & A management list, the question is expired;
A closed status unit, wherein the resolved and expired questions are changed to the closed status and do not accept any new answer, and the paid answer that is not viewed cannot be viewed again.
